(19) United States
(12) Patent Application Publication
(10) Pub. No.: US 2025/0210672 A1
(43) Pub. Date: Jun. 26, 2025

(54) MEMBRANE-ELECTRODE ASSEMBLY

(71) Applicant: SAMSUNG ELECTRO-MECHANICS CO., LTD., Suwon-si (KR)

(72) Inventors: Sun Il JEONG, Suwon-si (KR); Byung Chul JANG, Suwon-si (KR); Hae Sol JUNG, Suwon-si (KR); Guh Hwan LIM, Suwon-si (KR); Tae Jun CHOI, Suwon-si (KR)

(73) Assignee: SAMSUNG ELECTRO-MECHANICS CO., LTD., Suwon-si (KR)

(21) Appl. No.: 18/976,694

(22) Filed: Dec. 11, 2024

(30) Foreign Application Priority Data
Dec. 22, 2023 (KR) 10-2023-0189727

(51) Int. Cl. H01M 4/92; C25B 9/23; C25B 11/031; C25B 11/054; C25B 11/065; C25B 11/067; C25B 11/081; H01M 4/86; H01M 8/10; H01M 8/1004

(52) U.S. Cl. CPC H01M 4/926; C25B 9/23; C25B 11/031; C25B 11/054; C25B 11/065; C25B 11/067; C25B 11/081; H01M 4/8605; H01M 4/8657; H01M 8/1004; H01M 2008/1095

(57) ABSTRACT

A membrane-electrode assembly includes first and second catalyst electrodes, and a polymer electrolyte membrane disposed between the first and second catalyst electrodes. The first catalyst electrode includes a first layer and a second layer disposed farther from the polymer electrolyte membrane than the first layer. The first layer includes a porous first support and a first catalyst disposed on a surface of the first support, and the second layer includes a porous second support and a second catalyst disposed on a surface of the second support. A porosity of the second support is higher than a porosity of the first support.

### CROSS-REFERENCE TO RELATED APPLICATION(S)

This application claims the benefit of priority to Korean Patent Application No. 10-2023-0189727 filed on Dec. 22, 2023 in the Korean Intellectual Property Office, the disclosure of which is incorporated herein by reference in its entirety.

### TECHNICAL FIELD

The present disclosure relates to a membrane-electrode assembly.

### BACKGROUND

Polymer electrolyte membrane fuel cells and polymer electrolyte membrane water electrolysis cells have been attracting attention due to high efficiency and miniaturization thereof, as eco-friendly energy source devices using hydrogen. Polymer electrolyte membrane fuel cells and polymer electrolyte membrane water electrolysis cells may generally include a membrane-electrode assembly (MEA) in which a polymer electrolyte membrane is disposed between catalyst electrodes, and the performance of the membrane-electrode assembly may greatly influence the performance of a fuel cell or a water electrolysis cell.

In general, such a membrane-electrode assembly may be manufactured by forming catalyst electrodes on both surfaces of a polymer electrolyte membrane. Here, the catalyst electrode may include a catalyst and a support supporting the catalyst. In order to improve the efficiency of a fuel cell or a water electrolysis cell, reaction efficiency in the catalyst electrode needs to be improved, and design options for catalytic electrodes having high efficiency have been studied.

### SUMMARY

An aspect of the present disclosure is to implement a membrane-electrode assembly having a catalyst electrode having high reaction efficiency. However, the aspect of the present disclosure is not limited to those set forth herein, and may include technical issues that may be realized by the means described in the claims and a combination thereof.

According to an aspect of the present disclosure, there is provided a membrane-electrode assembly including first and second catalyst electrodes, and a polymer electrolyte membrane disposed between the first and second catalyst electrodes. The first catalyst electrode may include a first layer and a second layer disposed farther from the polymer electrolyte membrane than the first layer. The first layer may include a porous first support and a first catalyst disposed on a surface of the first support, and the second layer may include a porous second support and a second catalyst disposed on a surface of the second support. A porosity of the second support may be higher than a porosity of the first support.

The first support may include a plurality of first support particles, and the first catalyst may include a plurality of first catalyst particles disposed on a surface of the first support particles. The second support may include a plurality of second support particles, and the second catalyst may include a plurality of second catalyst particles disposed on a surface of the second support particles.

A diameter of the first support particle may be less than a diameter of the particle of the second support.

A diameter of the first support particle may be 100 nm or less.

A diameter of the second support particle may be 200 nm or more.

A content of the first catalyst may be greater than a content of the second catalyst.

In the first layer, a content of the first catalyst may be 5 wt % to 20 wt % relative to a total content of the first support and the first catalyst.

In the second layer, a content of the second catalyst may be 1 wt % to 8 wt % relative to a total content of the second support and the second catalyst.

The first support and the second support may include at least one of antimony tin oxide (ATO), indium tin oxide (ITO), fluorine doped tin oxide (FTO), TiO₂, Ti₂O₃, Ti₃O₅, Ti₄O₇, CeO₂, carbon black, carbon nanotubes (CNT), graphene flakes, graphene oxide (GO), reduced graphene oxide (RGO). The first catalyst may include at least one of an Ir-based material, a Ru-based material, a Pt-based material, a Pd-based material, and an Au-based material.

The first catalyst electrode may be disposed farther from the polymer electrolyte membrane than the second layer, and may include a porous third support and a third catalyst disposed on a surface of the third support. A porosity of the third support is higher than a porosity of the second support.

The first support may include a first main support and a plurality of first sub-supports disposed on a surface of the first main support. The first catalyst may be disposed on a surface of the first sub-support.

The first main support may include C. The first sub-support may include at least one of a Pt-based material, a Ru-based material, a Ni-based material, a Co-based material, a Sn-based material, a Cr-based material, and a Zn-based material. The first catalyst may include IrO₂.

The first catalyst may include a plurality of first sub-support particles disposed on a surface of the first sub-support.

The second support may include a second main support and a plurality of second sub-supports disposed on a surface of the second main support. The second catalyst may be disposed on a surface of the second sub-support.

The second main support may include C. The second sub-support may include at least one of a Pt-based material, a Ru-based material, a Ni-based material, a Co-based material, a Sn-based material, a Cr-based material, and a Zn-based material. The second catalyst may include IrO₂.

The second catalyst may include a plurality of second sub-support particles disposed on a surface of the second sub-support.

A membrane-electrode assembly according to an example of the present disclosure may include a catalyst electrode having high reaction efficiency, and accordingly may have improved performance when the membrane-electrode assembly is used as a fuel cell or a water electrolysis cell.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic exploded perspective view of a membrane-electrode assembly according to an example embodiment of the present disclosure;

FIG. 2 is a cross-sectional view of one region of a membrane-electrode assembly;

FIG. 3 is an enlarged view of components of a first catalyst electrode;

FIG. 4 is a perspective view of a first support and a first catalyst;

FIG. 5 is a perspective view of a second support and a second catalyst; and

FIGS. 6 to 10 illustrate components of a membrane-electrode assembly according to a modification.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

In order to clearly illustrate the present disclosure, portions not related to the description are omitted, and sizes and thicknesses are magnified in order to clearly represent layers and regions, and similar portions having the same functions within the same scope are denoted by similar reference numerals throughout the specification. Throughout the specification, when an element is referred to as “comprising” or “including,” it means that it may include other elements as well, rather than excluding other elements, unless specifically stated otherwise.

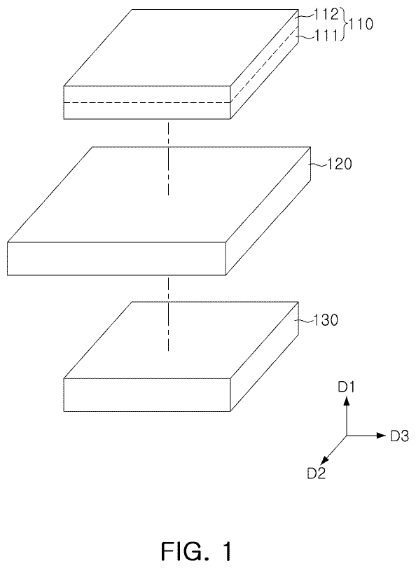

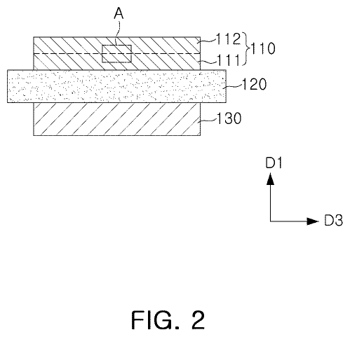

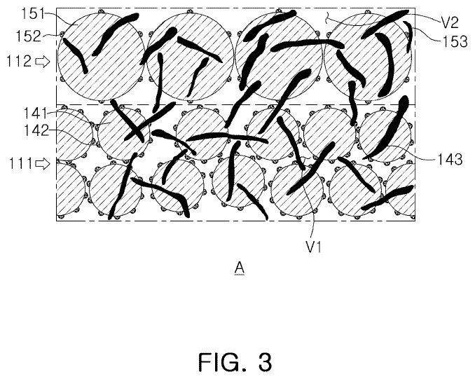

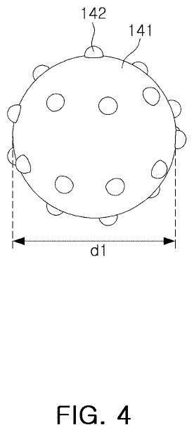

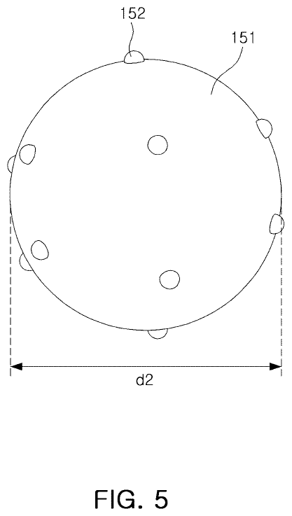

FIG. 1 is a schematic exploded perspective view of a membrane-electrode assembly according to an example embodiment of the present disclosure. FIG. 2 is a cross-sectional view of one region of a membrane-electrode assembly. FIG. 3 is an enlarged view of components of a first catalyst electrode. FIG. 4 is a perspective view of a first support and a first catalyst. FIG. 5 is a perspective view of a second support and a second catalyst.

First, referring to FIGS. 1 and 2, a membrane-electrode assembly 100 according to an example embodiment of the present disclosure may include a first catalyst electrode 110, a polymer electrolyte membrane 120, and a second catalyst electrode 130 as main components, and the polymer electrolyte membrane 120 may be disposed between the first and second catalyst electrodes 110 and 130. Here, a porosity of a second support 151, included in a second layer 112 of the first catalyst electrode 110, may be higher than a porosity of a first support 141, included in a first layer 111 of the first catalyst electrode 110. Such a structure may allow the first support 141 in the first layer 111 close to the polymer electrolyte membrane 120 to have a high level of surface area, such that a content of the first catalyst 142 supported thereon may be increased, and a high porosity in the second layer 112, disposed relatively far from the polymer electrolyte membrane 120, may facilitate a flow of fluid. Accordingly, the first catalyst electrode 110 may have improved reaction efficiency, and may have improved properties when the membrane-electrode assembly 100 is used as a fuel cell, a water electrolysis cell, or the like. Hereinafter, components of the membrane-electrode assembly 100 will be described in detail, and a case in which the membrane-electrode assembly 100 is a water electrolysis battery will be mainly described. However, the membrane-electrode assembly 100 may be used as a fuel cell. In this case, the first catalyst electrode 110 and the second catalyst electrode 130 of the membrane-electrode assembly 100 may have a reaction opposite to that of the case in which the membrane-electrode assembly 100 is used as a water electrolysis cell.

The first catalyst electrode 110 may include the first layer 111 and the second layer 112 disposed farther from the polymer electrolyte membrane 120 than the first layer 111. The first layer 111 may include a porous first support 141 and a first catalyst 142 disposed on a surface of the first support 141, and the second layer 112 may include a porous second support 151 and a second catalyst 152 disposed on a surface of the second support 151. In addition, pores V1 and V2 may be formed in the first catalyst electrode 110, such that gas, liquid, and the like may move freely. Here, a porosity of the second support 151 may be higher than that of the first support 141.

The first support 141 and the second support 151 may support the first catalyst 142 and the second catalyst 152, respectively, and may have a high surface area in which a catalyst material is formed, and thus may function to maintain high catalytic activity of the first catalyst electrode 110 even without significantly increasing an amount of catalyst material. In consideration of such functions, the first support 141 and the second support 151 may include at least one of antimony tin oxide (ATO), indium tin oxide (ITO), fluorine doped tin oxide (FTO), TiO₂, Ti₂O₃, Ti₃O₅, Ti₄O₇, CeO₂, carbon black, carbon nanotubes (CNT), graphene flakes, graphene oxide (GO), reduced graphene oxide (RGO).

The first catalyst 142 and the second catalyst 152 may be disposed on the surfaces of the first support 141 and the second support 151, respectively. The first catalyst 142 and the second catalyst 152 that are active in an oxygen generation reaction may include at least one of an Ir-based material, a Ru-based material, a Pt-based material, a Pd-based material, and an Au-based material, and IrO₂ may be used as a representative example.

In addition to the first and second supports 141 and 151 and the catalysts 142 and 152, the first catalyst electrode 110 may include ion conductors 143 and 153. Specifically, the first layer 111 and the second layer 112 may include first and second ion conductors 143 and 153, respectively. The first and second ion conductors 143 and 153 may provide a path for movement of hydrogen ions generated in the first catalyst electrode 110, and may include, for example, a fluorine-based ionomer, a carbon hydrogen-based ionomer, and a mixture thereof. As a specific example, the first and second ion conductors 143 and 153 may include a perfluorinated sulfonic acid-based ionomer. As an example of manufacturing the first catalyst electrode 110, an electrode material including supports 141 and 151, catalysts 142, 152, and ion conductors 143 and 153 may be obtained in a paste form, and then coated on one surface of the polymer electrolyte membrane 120 using a method such as spray coating or the like, and then subjected to a curing process to form the first catalyst electrode 110. In addition, in a method of forming the catalysts 142 and 152 on the surfaces of the supports 141 and 151, an atomic layer deposition may be used. The catalysts 142 and 152 may be formed thinly and uniformly using the atomic layer deposition process, and thus may have improved efficiency.

When the membrane-electrode assembly 100 is used as a water electrolysis battery, water supplied to the first catalyst electrode 110 that is an anode may be separated into oxygen (O₂), hydrogen ions (H+, Proton), and electrons. Here, the hydrogen ions may move to the second catalyst electrode 130 through the polymer electrolyte membrane 120, and the electrons may move to the second catalyst electrode 130 through an external circuit and a power supply.

The polymer electrolyte membrane 120 may include an ion conductor to provide a moving path such as hydrogen ions. Here, the ion conductor of the polymer electrolyte membrane 120 may include, for example, a fluorine-based ionomer, a carbon hydrogen-based ionomer, and a mixture thereof. As a specific example, the ion conductor may include a perfluorinated sulfonic acid-based ionomer. When the membrane-electrode assembly 100 is used as a water electrolysis battery, hydrogen ions, generated in the first catalyst electrode 110, may move to the second catalyst electrode 130 through the polymer electrolyte membrane 120.

The second catalyst electrode 130 may include a catalyst material. Here, the catalyst material of the second catalyst electrode 130 may be provided in a form of being supported on a support in a similar manner to that of the first catalyst electrode 110. Here, the support of the second catalyst electrode 130 may use a carbon-based support. In addition, the second catalyst electrode 130 may include an ion conductor in addition to the catalyst material. The catalyst material of the second catalyst electrode 130 that is active in a hydrogen oxidation reaction or an oxygen reduction reaction may include at least one of a Pt-based material, an Au-based material, a Ru-based material, an Os-based material, and a Pd-based material. In a water electrolysis battery, the second catalyst electrode 130 may be a cathode and hydrogen ions supplied through the polymer electrolyte membrane 120 may react with electrons to generate hydrogen.

In the above descriptions, a case in which the first catalyst electrode 110 and the second catalyst electrode 130 are an anode and a cathode, respectively, may be used as an example, but a structure opposite to that of the case may also be possible. That is, as a modification, in the membrane-electrode assembly 100, the first catalyst electrode 110 may be a cathode, and the second catalyst electrode 130 may be an anode.

A specific form of the first catalyst electrode 110 will be described. Referring to FIGS. 3 to 5, as described above, in the first catalyst electrode 110, a porosity of the second layer 112 disposed far from the polymer electrolyte membrane 120 may be relatively increased so as to facilitate a flow of fluid in a region close to an inlet or an outlet of the fluid. In other words, the volume of pores V2 in the second layer 112 may be greater than the volume of pores V1 in the first layer 111. In addition, in the first layer 111 having a relatively low porosity, the first support 141 may have a large surface area, such that a content of the first catalyst 142 may be increased. Thus, high reaction efficiency may be obtained in a region close to the polymer electrolyte membrane 120. A porosity of the first catalyst electrode 110 may refer to a volume fraction of pores present in the first catalyst electrode 110, but may be measured through an image of a cross-section after the membrane-electrode assembly 100 is manufactured. As a specific example, in a cross-section of the first catalyst electrode 110 in first and third directions D1 and D3 obtained in a central portion of the first catalyst electrode 110 in a second direction D2, when an area of the first layer 111 is set to 100%, the porosity may be expressed as a percentage by calculating a remaining area excluding an area occupied by the first support 141 as an area of the pores. Such a method may also be applied to the second layer 112. In this case, in order to increase the accuracy of porosity calculation, porosities may be measured in additional cross-sections (for example, ten additional cross-sections of the central portion of the first catalyst electrode 110 in the second direction D2, equally spaced apart from each other in both directions) in addition to the cross-section of the first catalyst electrode 110 in the first and third directions D1 and D3 obtained in the central portion of the first catalyst electrode 110 in the second direction D2, thereby obtaining an average value of the porosities.

As illustrated in the drawings, the first support 141 includes a plurality of particles. In this case, the first catalyst 142 may include a plurality of particles disposed on a surface of the particle of the first support 141. Similarly, the second support 151 may include a plurality of particles. In this case, the second catalyst 152 may include a plurality of particles disposed on a surface of the particle of the second support 151. As illustrated in the drawings, the particles included in the first and second catalysts 142 and 152 may have a spherical shape or a basic shape similar to the spherical shape, and may be partially cut off. When the first and second catalysts 142 and 152 are respectively grown on the surfaces of the first and second supports 141 and 151, the particles included in the first and second catalysts 142 and 152 may be disposed such that a region thereof having a largest diameter is in contact with the first and second supports 141 and 151.

Sizes of the particles of the first and second supports 141 and 151 may be adjusted such that a plurality of regions having different porosity are present in the first catalyst electrode 110. Specifically, a diameter D1 of the particle of the first support 141 may be less than a diameter D2 of the particle of the second support 151. As a more specific example, the diameter D1 of the particle of the first support 141 may be 100 nm or less, and the diameter D2 of the particle of the second support 151 may be 200 nm or more. Here, the diameters of the particles of the first support 141 and the second support 151 may be measured based on a cross-section. As a specific example, in the cross-section of the first catalyst electrode 110 in the first and third directions D1 and D3 obtained in the central portion of the first catalyst electrode 110 in the second direction D2, the diameters (or equivalent-circle diameters) of the particles of the first support 141 and the second support 151 may be measured, and an average value of the multiple particles may be used. In this case, in order to increase the accuracy of diameter calculation, the diameters of the particles may be measured in additional cross-sections (for example, ten additional cross-sections of the central portion of the first catalyst electrode 110 in the second direction D2, equally spaced apart from each other in both directions) in addition to the cross-section of the first catalyst electrode 110 in the first and third directions D1 and D3 obtained in the central portion of the first catalyst electrode 110 in the second direction D2, thereby obtaining an average value of the diameters of the particles.

In the present example embodiment, the first layer 111 of the first catalyst electrode 110, disposed to be close to the polymer electrolyte membrane 120, may have a relatively high catalyst content rather than the overall first catalyst electrode 110 having a uniform catalyst content, such that a high level of reaction efficiency may be ensured without significantly increasing an amount of catalyst. Specifically, a content of the first catalyst 142 in the first layer 111 may be greater than a content of the second catalyst 152 in the second layer 112. As a more specific example, the content of the first catalyst 142 may be 5 wt % to 20 wt % relative to a total content of the first support 141 and the first catalyst 142 in the first layer 111. In addition, the content of the second catalyst 152 may be 1 wt % to 8 wt % relative to a total content of the second support 151 and the second catalyst 152 in the second layer 112. The contents of the first catalyst 142 and the second catalyst 152 may be measured using cross-section analysis. Specifically, a molar content of each element may be measured in a focused ion beam (FIB) image of the cross-section of the first catalyst electrode 110 in the first and third directions D1 and D3 obtained in the central portion of the first catalyst electrode 110 in the second direction D2, and the molar content may be converted into wt %. In this case, as described above, molar contents may be measured in cross-sections in addition to the cross-section of the first catalyst electrode 110 in the first and third directions D1 and D3 obtained in the central portion of the first catalyst electrode 110 in the second direction D2, thereby obtaining an average value of the molar contents.

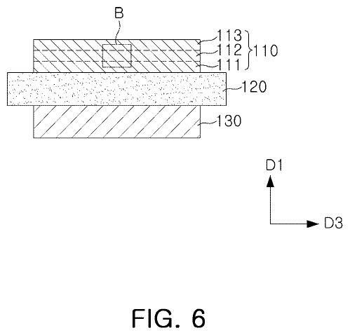

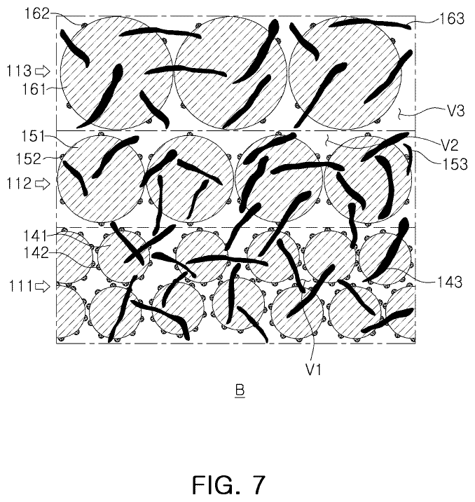

Hereinafter, membrane-electrode assemblies according to modified example embodiments will be described with reference to FIGS. 6 to 10. The following modifications may be combined with the basic example embodiment solely or in combination with each other.

First, in the modification of FIG. 6, the first catalyst electrode 110 may further include a third layer 113 having a different porosity. Specifically, the first catalyst electrode 110 may further include a third layer 113 in addition to the first layer 111 and the second layer 112, and the third layer 113 may be disposed farther from the polymer electrolyte membrane 120 than the second layer 112. The third layer 113 may include a porous third support 161 and a third catalyst 162 disposed on a surface of the third support 161, and may further include a third ion conductor 163. A porosity of the third support 161 may be higher than a porosity of the second support 151, and accordingly the volume of pores V3 in the third layer 113 may be greater than the volume of pores V2 of the second layer 112. That is, in a direction away from the polymer electrolyte membrane 120, the porosity of the second support 151 may be higher than that of the first support 141, and the porosity of the third support 161 may be higher than that of the second support 151. Conversely, in the case of the catalyst, a content of the third catalyst 162 may be higher than that of the second catalyst 152. As described above, the first catalyst electrode 110 may be further divided into three regions having different porosities. The first catalyst electrode 110 may be implemented to include four or more regions, as necessary.

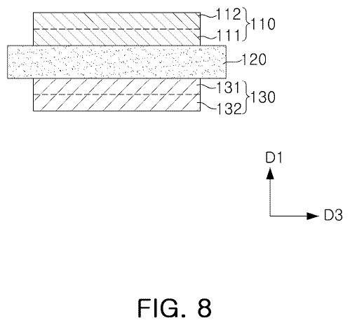

In the modification of FIG. 8, in addition to the first catalyst electrode 110, the second catalyst electrode 130 may also include regions having different porosities, thereby improving catalyst efficiency over the entire membrane-electrode assembly 100. Specifically, the second catalyst electrode 130 may have substantially the same structure in terms of a porosity of a support or a catalyst content of the first catalyst electrode 110. For example, the second catalyst electrode 130 may have a first layer 131 having a relatively low porosity and a relatively high catalyst content, and a second layer 132 having a relatively high porosity and a relatively low catalyst content. In this case, unlike the form illustrated in FIG. 8, only the second catalyst electrode 130, other than the first catalyst electrode 110, may be implemented to include the above-described porosity displacement structure, that is, the first layer 131 and the second layer 132.

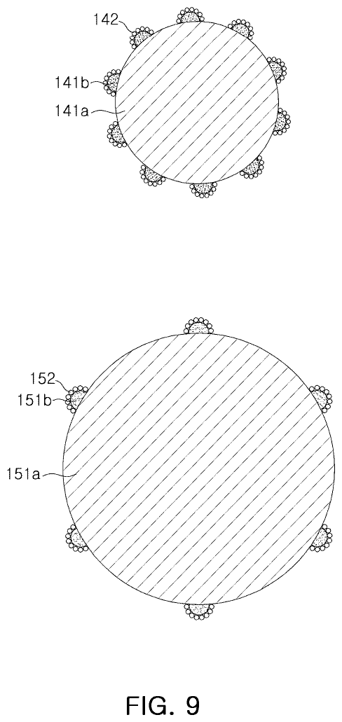

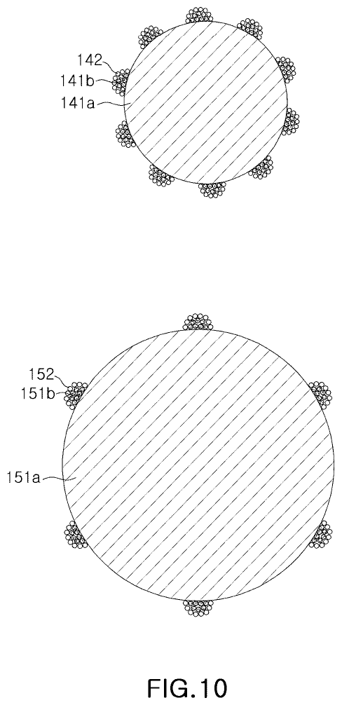

In the modification of FIG. 9 and FIG. 10, a support may include a main support and a sub-support, such that a surface area may be further increased. Specifically, the first support 141 may include a first main support 141a and a plurality of first sub-supports 141b disposed on a surface of the first main support 141a, and the first main support 141a and the plurality of first sub-supports 141b may be formed of different materials. In this case, as illustrated in FIG. 10, each of the plurality of first sub-supports 141b may have a structure in which a plurality of particles are aggregated. The first catalyst 142 may be disposed on a surface of the first sub-support 141b, and may include a plurality of particles disposed on the surface of the first sub-supports 141b. As a specific example of the material, the first main support 141a may include C, and the first sub-support 141b may include at least one of a Pt-based material, a Ru-based material, a Ni-based material, a Co-based material, a Sn-based material, a Cr-based material, and a Zn-based material. In addition, the first catalyst 142 may include IrO₂. Similarly, the second support 151 may include a second main support 151a and a plurality of second sub-supports 151b disposed on a surface of the second main support 151a, and the second main support 151a and the plurality of second sub-supports 151b may be formed of different materials. Each of the plurality of second sub-supports 151b may have a structure in which a plurality of particles are aggregated. The second catalyst 152 may be disposed on a surface of the second sub-support 151b, and may include a plurality of particles disposed on the surface of the second sub-supports 151b. In addition, the second main support 151a may include C, and the second sub-support 151b may include at least one of a Pt-based material, a Ru-based material, a Ni-based material, a Co-based material, a Sn-based material, a Cr-based material, and a Zn-based material. In addition, the second catalyst 152 may include IrO₂.

As illustrated in the modification of FIG. 9 and FIG. 10, the first sub-support 141b and the second sub-support 151b may be disposed separately from the first main support 141a and the second main support 151a, respectively, thereby increasing a surface area of the support. Accordingly, surface areas of the first catalyst 142 and the second catalyst 152 respectively disposed on the surfaces of the first sub-support 141b and the second sub-support 151b may also be increased, such that the catalysts may have improved efficiency. As an example of a process, the first sub-support 141b, the second sub-support 151b, the first catalyst 142, and the second catalyst 152 may be formed using the atomic layer deposition described above. The above-described catalysts may be formed thinly and uniformly using the atomic layer deposition process, such that the catalysts may have improved efficiency.

While example embodiments have been shown and described above, it will be apparent to those skilled in the art that modifications and variations could be made without departing from the scope of the present disclosure as defined by the appended claims.

What is claimed is:

1. A membrane-electrode assembly comprising:
first and second catalyst electrodes; and
a polymer electrolyte membrane disposed between the first and second catalyst electrodes,
wherein the first catalyst electrode includes a first layer and a second layer disposed farther from the polymer electrolyte membrane than the first layer,
the first layer includes a porous first support and a first catalyst disposed on a surface of the first support, and the second layer includes a porous second support and a second catalyst disposed on a surface of the second support, and
a porosity of the second support is higher than a porosity of the first support.

2. The membrane-electrode assembly of claim 1, wherein
the first support includes a plurality of first support particles, and the first catalyst includes a plurality of first catalyst particles disposed on a surface of the first support particles, and
the second support includes a plurality of second support particles, and the second catalyst includes a plurality of second catalyst particles disposed on a surface of the second support particles.

3. The membrane-electrode assembly of claim 2, wherein a diameter of the first support particles is less than a diameter of the second support particles.

4. The membrane-electrode assembly of claim 2, wherein a diameter of the first support particles is 100 nm or less.

5. The membrane-electrode assembly of claim 2, wherein a diameter of the second support particles is 200 nm or more.

6. The membrane-electrode assembly of claim 1, wherein a content of the first catalyst is greater than a content of the second catalyst.

7. The membrane-electrode assembly of claim 1, wherein, in the first layer, a content of the first catalyst is 5 wt % to 20 wt % relative to a total content of the first support and the first catalyst.

8. The membrane-electrode assembly of claim 1, wherein, in the second layer, a content of the second catalyst is 1 wt % to 8 wt % relative to a total content of the second support and the second catalyst.

9. The membrane-electrode assembly of claim 1, wherein
the first support and the second support include at least one of antimony tin oxide (ATO), indium tin oxide (ITO), fluorine doped tin oxide (FTO), TiO₂, Ti₂O₃, Ti₃O₅, Ti₄O₇, CeO₂, carbon black, carbon nanotubes (CNT), graphene flakes, graphene oxide (GO), reduced graphene oxide (RGO), and
the first catalyst includes at least one of an Ir-based material, a Ru-based material, a Pt-based material, a Pd-based material, and an Au-based material.

10. The membrane-electrode assembly of claim 1, wherein
the first catalyst electrode is disposed farther from the polymer electrolyte membrane than the second layer, and includes a porous third support and a third catalyst disposed on a surface of the third support, and
a porosity of the third support is higher than a porosity of the second support.

11. The membrane-electrode assembly of claim 1, wherein
the first support includes a first main support and a plurality of first sub-supports disposed on a surface of the first main support, and
the first catalyst is disposed on a surface of the first sub-support.

12. The membrane-electrode assembly of claim 11, wherein
the first main support includes C,
the first sub-support includes at least one of a Pt-based material, a Ru-based material, a Ni-based material, a Co-based material, a Sn-based material, a Cr-based material, and a Zn-based material, and
the first catalyst includes IrO₂.

13. The membrane-electrode assembly of claim 11, wherein the first catalyst includes a plurality of first catalyst particles disposed on a surface of the first sub-support.

14. The membrane-electrode assembly of claim 11, wherein
the second support includes a second main support and a plurality of second sub-supports disposed on a surface of the second main support, and
the second catalyst is disposed on a surface of the second sub-support.

15. The membrane-electrode assembly of claim 14, wherein
the second main support includes C,
the second sub-support includes at least one of a Pt-based material, a Ru-based material, a Ni-based material, a Co-based material, a Sn-based material, a Cr-based material, and a Zn-based material, and
the second catalyst includes IrO₂.

16. The membrane-electrode assembly of claim 14, wherein the second catalyst includes a plurality of second catalyst particles disposed on a surface of the second sub-support.

17. A fuel cell comprising the membrane-electrode assembly of claim 1.

18. A catalyst electrode for a membrane-electrode assembly, comprising:
a first layer including a porous first support and a first catalyst disposed on a surface of the first support and having a first surface proximal to a polymer electrolyte membrane;
a second layer disposed on a second surface of the first layer opposing the first surface, the second layer including a porous second support and a second catalyst disposed on a surface of the second support, the second support having higher porosity than the first support.

19. The catalyst electrode of claim 18, wherein the first support comprises first support particles, and the second support comprises second support particles having a diameter greater than that of the first support particles.

20. The catalyst electrode of claim 18, wherein a content of the first catalyst is greater than a content of the second catalyst.

21. The catalyst electrode of claim 18, wherein the first support and the second support include at least one of antimony tin oxide (ATO), indium tin oxide (ITO), fluorine doped tin oxide (FTO), TiO₂, Ti₂O₃, Ti₃O₅, Ti₄O₇, CeO₂, carbon black, carbon nanotubes (CNT), graphene flakes, graphene oxide (GO), reduced graphene oxide (RGO), and
the first catalyst includes at least one of an Ir-based material, a Ru-based material, a Pt-based material, a Pd-based material, and an Au-based material.

22. A fuel cell comprising a catalyst electrode of claim 18.
